(19) United States
(12) Patent Application Publication
(10) Pub. No.: US 2026/0073293 A1
(43) Pub. Date: Mar. 12, 2026

(54) REAL TIME DETECTION, PREDICTION AND REMEDIATION OF MACHINE LEARNING MODEL DRIFT IN ASSET HIERACHY BASED ON TIME-SERIES DATA

(71) Applicant: HITACHI VANTARA LLC, Santa Clara, CA (US)

(72) Inventors: Yongqiang ZHANG, Lexington, MA (US); Wei LIN, Plainsboro, NJ (US)

(21) Appl. No.: 19/106,168

(22) PCT Filed: Aug. 24, 2022
(86) PCT No.: PCT/US2022/041397

§ 371 Date: Feb. 24, 2025

(51) Int. Cl. G06N 20/00; G06F 17/18; G06F 18/10; G06F 18/21; G06F 18/22; G06F 18/2321; G06F 123/02; G06N 3/044

(52) U.S. Cl. CPC G06N 20/00; G06F 17/18; G06F 18/10; G06F 18/217; G06F 18/22; G06F 18/2321; G06N 3/044; G06F 2123/02

(57) ABSTRACT

Model drift management of one or more machine learning models deployed across one or more physical systems, including executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and executing a second process configured to predict model drift from the one or more deployed machine learning models, the second process configured to intake the output model drifts from the first machine learning model and the time series sensor data to output predicted model drift of the one or more deployed machine learning models, wherein the second process is another machine learning model.

### BACKGROUND

### Field

The present disclosure is generally directed to Internet of Things (IOT) and machine learning domains, and more specifically, to real time detection, prediction, and remediation of machine learning model drift in asset hierarchy based on time series data.

Machine Learning (ML) is a technology that is used to train or teach machines to perform various actions such as predictions, recommendations, estimations, optimization, and so on, based on historical data or past experience. Machine Learning allows computers to behave like human beings by training them with the help of past experience and predicted data. Machine Learning techniques are divided mainly into the following three major categories.

Supervised learning is applicable when a machine has historical training data, which consists of features and labels. Supervised learning techniques analyze the training data, find the relationship between features and labels, and then represent such relationships as a machine learning models. The trained machine learning model will help predict future events against the features in the testing dataset. Many supervised model algorithms are designed and developed, which includes but not limited to logistics regression, decision tree, random forest, support vector machine, neural network, and so on.

Unsupervised learning is applicable when a machine has historical training data, which involves only features. The label for each sample is unknown (i.e., the training information is neither classified nor labeled). Unsupervised learning techniques explore the training data and draw inferences from datasets to describe hidden structures from unlabeled data. Such inference results can be used for the business insights or as features for building the supervised machine learning models. Unsupervised machine learning is less popular used in the problems compared to the supervised counterpart, but many unsupervised machine learning algorithms have been developed, which include but not limited to clustering algorithms, anomaly detection algorithms and principal component analysis algorithms.

Reinforcement Learning is a feedback-based machine learning technique. In this type of learning, agents (computer programs) need to explore the environment, perform actions, and on the basis of their actions, obtain rewards as feedback. For each good action, they get a positive reward, and for each bad action, they get a negative reward. The goal of a reinforcement learning agent is to maximize the long-term positive rewards. Since there is no labeled data, the agent is bound to learn from its experience only. Many reinforcement learning algorithms have been developed, including but not limited to: multi-arm bandit, queue learning, deep queue learning, Actor Critic, and so on.

Given the historical training data, different types of machine learning models can be trained with different model algorithms as described above, optimize the parameters and hyperparameters for each model algorithm in order to find the best model to solve the business problem. The output from model development process will be a trained machine learning model.

The trained machine learning model will be then deployed and start accepting new data for model inference, which can be performed in either real time mode or batch mode. There are techniques and tools to define, prepare and execute the deployment process, including but not limited to MLFlow, Docker, Kubernetes, Seldon Core, and so on.

The deployed model accepts new data and makes inference against the data. The quality of the inference results reflects the performance of the deployed model against the new data. Since the new data may change compared to the historical training data, the model may or may not perform well. The machine learning model(s) become drifted (or shifted) after they are deployed for some time. The output from the drifted model(s) becomes inaccurate and unreliable when the drifted model(s) are applied to the new data. When the deployed model performs worse in the testing environment (or live environment) compared to the training performance, such a phenomenon is known as model drifting.

There are two types of model drift. Data drift occurs when the distribution of input data shifts between the training environment and testing environment (or live environment). Concept drift occurs when the pattern or the relationship between the input and target output changes.

Model drift can occur gradually over time or suddenly after deployment. The model drift issue has an adverse effect on the accuracy of the model, and thus the incorrect output from the model(s) could have adverse impacts on business, security and health, and so on. There is an urgent need to detect model drift and take remediation actions to avoid any wrong decisions based on the output from such drifted model(s).

Model drift detection process needs to be enforced to monitor the data and the performance of the deployed model. Model monitoring and drift detection is an important part of the ML Model Lifecycle, or MLOps process, which needs to be optimized for successful and efficient deployments of models into production. Identifying any kind of drifts in the data in real-time and a proper strategy to handle such drifts can be very crucial for machine learning models to provide reliable results.

Manual check or schedule-based inspection of model drift is insufficient in that it may not capture the model drift in time while unnecessary inspection incurs the cost. Also, such manual inspection may be error-prone and time-consuming. Some existing related art work has been done to automate the drift detection through some specially design algorithms.

Once model drifts are detected, re-training the model is a common practice to solve the model drift problem. Then, different versions of the model need to be managed so that the proper versions of the model will be in place for the model inference.

Another method is to predict model drift ahead of time, which allows some buffer time to remediate the model drifts before it really happens. Such solutions can bring more business values.

### Asset Hierarchy

An asset hierarchy is a logical and/or physical way to organize all the assets within an industrial entity, such as machines, equipment and individual components. There can be two types of relationships among the assets.

Compositional (or parent-child) relationship is when the assets can be organized in a tree-like structure where the assets have compositional (or parent-child) relationship. An example of learning methods within asset hierarchy based on parent-child relationship among assets is described, for example, in SOLUTION LEARNING AND EXPLAINING IN ASSET HIERARCHY, PCT Application No.: PCT/US2021/039863, herein incorporated by reference.

Sequential relationship is when the assets can be organized in a pipeline where one asset start performing the predefined task after another asset finishes the task. An example of the learning methods within asset hierarchy based on sequential relationship among assets is described in DIGITAL TWIN SEQUENTIAL AND TEMPORAL LEARNING AND EXPLAINING, PCT Application No.: PCT/US2021/065717, herein incorporated by reference.

The Internet of Things (IOT) and Operational Technology (OT) offer great potential to change the way in which systems function and businesses operate by efficiently monitoring and automating the systems without the need for human interaction or involvement. IoT and OT systems will rely on massive amounts of data to automate the system operation and decision making and such data are collected by sensors.

Sensors are devices that respond to inputs from the physical world, capture the inputs and transmit them into the storage device. The data will be processed with techniques in data analytics, data mining, machine learning and artificial intelligence, so as to make intelligent decisions, adjust operating conditions and automate system operations.

In a related art implementation, there is a sidecar learning model that receives operational input data submitted to a predictive learning model to automatically detect the model drift. The model is based on multi-variate anomaly detection model (GMM, AutoEncoder, and so on) against the same training data that are used to train the predictive learning model. A deviation of the operational input data from the training data is determined. The sidecar learning model generates a drift signal that characterizes the deviation of the operational input data from the training data.

One drawback for this related art solution is that the output from the multi-variate anomaly detection models may include the operational anomalies; that is, the detected anomalies do not have to be the model drifts.

Another related art implementation introduces systems and methods for processing streams of data through centroids histograms, essentially a distribution of the streams of the data. In such a related art, the implementations identify and monitor drift over time as well as detect both data drift and model inaccuracies. Data drifting is detected through comparing data distributions (histograms) of training data and scoring data. This also includes optimized binning strategy based on centroids histograms and optimized data drifting metrics; identifying the important features with data drifting, and so on. Model inaccuracies is detected through comparing prediction results and ground truth. Taking corrective actions in response to data drift and model inaccuracies by retraining the model or use a challenger model.

Such related art implementations introduce algorithms for detection of model drifts. The algorithms are specially designed.

### SUMMARY

Several limitations and restrictions of conventional systems and methods are discussed below. The example implementations described herein introduce techniques to solve these problems.

In a first problem, the model drifts are detected with manual or automated approaches with specially designed algorithms in the related art. The related art algorithms may or may not work well for all the cases. Further, the model drifting detection algorithms may not distinguish the model drifts from operational anomalies. Therefore, there is a need to identify the model drifts with some generic algorithms that can be applied to time series data and distinguish the model drifts from the operational anomalies in the underlying systems.

In a second problem, the model drifts are detected when the drifts have already happened, and thus the faults cannot be remediated or avoided in time in the related art implementations. Therefore, there is a need to predict the model drifts through automated data-driven machine learning approaches.

In a third problem, the model drifts are detected independently for each model that is built for each asset in the industrial systems in the related art. Thus, the relationships among the assets are not considered and utilized. Therefore, there is a need to utilize the relationships among assets to build machine learning model(s) for each asset, and perform model drifting detection and prediction by utilizing the relationships among assets.

In a fourth problem, concept drifting is usually done in a batch mode, where the labels for both training data and testing data are available in the related art. There are no solutions found for concept drift detection in the real-time mode in the related art. Further, there are no solutions found for real time detection of a combination of data drift and concept drift in the related art. Therefore, there is a need to design solutions for concept drifting detection in real-time model and ensemble the data drifting detection model and concept drifting detection model in real-time mode.

The models for assets in an asset hierarchy can also be drifted and such drifting problems need to be addressed with some special treatments. The present disclosure introduces some automated solution(s) to solve the model drift issue in asset hierarchy. In general, the solutions introduced herein can be applied to non-cyclic asset hierarchy.

Further, to solve the problems indicated above, the present disclosure introduces several example implementations herein.

Real Time Model Drift Detection detects data drift and concept drift for machine learning models. The present disclosure involves example implementations that introduce solution(s) to detect data drift, introduce solution(s) to detect concept drift, and introduce solution(s) to ensemble the data drift and concept drift solutions.

Real Time Model Drift Prediction predicts data drift and concept drift for machine learning models. Example implementations described herein apply a deep learning Recurrent Neural Network (RNN) model to predict data drift and concept drift concurrently. Both sensors and model performance data are used to build the model drift prediction model.

Real Time Model Drift Remediation remediates the impacts of drift for machine learning models. Example implementations described herein take actions to remediate the impact of detected model drift and predicted model drift, and also conduct re-training of models by using the latest data.

Real Time Model Drift Detection, Prediction and Remediation in Asset Hierarchy introduce solution(s) to detect, predict and remediate model drift (data drift and concept drift) in the asset hierarchy. In example implementations, the asset hierarchy can be physical or logical, and can also be non-cyclic, including a compositional (or parent-child) relationship or a sequential relationship.

Related art implementations are incapable of predicting model drifts. Further, the related art implementations are incapable of detecting model drifting problems in the asset hierarchy. The proposed methods described herein include both of these capabilities.

Aspects of the present disclosure can involve a method for model drift management of one or more machine learning models deployed across one or more physical systems, the method involving executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and executing a second process configured to predict model drift from the one or more deployed machine learning models, the second process configured to intake the output detected model drifts from the first process and the time series sensor data to output predicted model drift of the one or more deployed machine learning models.

Aspects of the present disclosure can involve computer program having computer instructions for model drift management of one or more machine learning models deployed across one or more physical systems, the instructions involving executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and executing a second process configured to predict model drift from the one or more deployed machine learning models, the second process configured to intake the output detected model drifts from the first process and the time series sensor data to output predicted model drift of the one or more deployed machine learning models. The computer program and instructions can be stored in a non-transitory computer readable medium and executed by one or more processors.

Aspects of the present disclosure can involve a system for model drift management of one or more machine learning models deployed across one or more physical systems, the system involving means for executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and means for executing a second process configured to predict model drift from the one or more deployed machine learning models, the second process configured to intake the output detected model drifts from the first process and the time series sensor data to output predicted model drift of the one or more deployed machine learning models.

Aspects of the present disclosure can involve an apparatus for model drift management of one or more machine learning models deployed across one or more physical systems, the apparatus involving a processor, configured to execute instructions including executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and executing a second process configured to predict model drift from the one or more deployed machine learning models, the second process configured to intake the output detected model drifts from the first process and the time series sensor data to output predicted model drift of the one or more deployed machine learning models.

### BRIEF DESCRIPTION OF DRAWINGS

FIG. 1 illustrates a solution architecture for model drift detection, prediction and remediation, in accordance with an example implementation.

FIG. 2 illustrates the workflow of the uni-variate data drift detection, in accordance with an example implementation.

FIG. 3 illustrates the workflow for the bi-variate model drift detection algorithm, in accordance with an example implementation.

FIG. 4 illustrates the workflow of the Bootstrap Micro Similarity, in accordance with an example implementation.

FIG. 5 describes a composite data drift detection approach, which introduces a logic to utilize both uni-variate and bi-variate data drift detection approaches, in accordance with an example implementation.

FIG. 6 is an illustration of the Multi-variate Concept Drifting Detection, in accordance with an example implementation.

FIG. 7 illustrates an algorithm to detect the concept drift based on model performance during training phase and testing phase, in accordance with an example implementation.

FIG. 8 illustrates a solution diagram for model drift prediction, in accordance with an example implementation.

FIG. 9 illustrates an example of asset hierarchy in a compositional relationship among assets, in accordance with an example implementation.

FIG. 10 illustrates a system involving a plurality of physical systems networked to a management apparatus, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

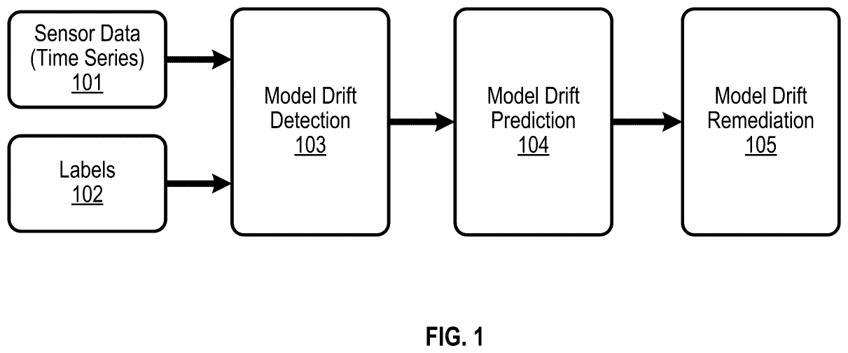

FIG. 1 illustrates a solution architecture for model drift detection, prediction and remediation, in accordance with an example implementation. The following is a brief description of each box in the solution architecture. Sensor Data 101 includes IoT sensor data in time series format, which can be physical sensor data and/or virtual sensor data. Labels 102 can involve the labels for the time series sensor data. This can be event data (or alert data) as well. Model Drift Detection 103 detects model drift, including data drift and concept drift. Model Drift Prediction 104 predicts model drift, including data drift and concept drift. Model Drift Remediation 105 takes actions to remediate detected and/or predicted model drifts. Each component in the solution architecture is described in detail below.

Sensor Data 101 can come from sensors, such as physical sensors and/or virtual sensors. Physical sensors are installed on the assets of interest and used to collect data to monitor the health and the performance of the asset. Different types of sensors are designed to collect different types of data among different industries, different assets and different tasks. In this context, there is no differentiation between the sensors, and it is assumed that most sensors can be fit into the solutions that are introduced here. In the present disclosure, there is a focus on the sensor data that are used to build machine learning models.

Sensors are designed to respond to specific types of conditions in the physical world, and then generate a signal (usually electrical) that can represent the magnitude of the condition being monitored. As the initiative from IoT and OT expands, there is a need to monitor and collect data of different types for analysis and processing, by using different types of sensors. Examples of sensors can include, but are not limited to, Temperature sensors, Pressure sensors, Vibration sensors, Acoustic sensors, Motion sensors, Level sensors, Image sensors, Proximity sensors, Water quality sensors, Chemical sensors, Gas sensors, Smoke sensors, Infrared (IR) sensors, Acceleration sensors, Gyroscopic sensors, Humidity sensors, Optical sensors, LIDAR sensors, and so on. The collected sensor data can be of different representations.

First of all, sensors can be analog sensors which attempt to capture continuous values and identify every nuance of what is being measured; or digital sensors which use sampling to encode what is being measured. As a result, the captured data can either be “analog data” or “digital data”. Second, the data can be numerical values, images or videos. Third, some sensors collect data in streaming manner and use time series data to represent the collected values. Other sensors collect data in isolated time points.

Virtual sensors are the output variables from the physics-based model or digital twin model, which can complement and/or validate the data from the physical sensors and thus help monitor and maintain the system health. For the “complement” case, when the physical sensor data is not available or not enough, virtual sensor data from the digital twin model can serve as a “substitute” of the physical sensors. For the “validate” case, assuming the physical sensors also collect the data as the outputs of the digital twin model, the virtual sensor data can serve as the “expected” value while the values from physical sensors can serve as the “observed” value and thus the variance or difference between them can be used as a signal to detect abnormal behaviors in the system.

There are situations in which the data collected by one sensor S1 is closely related to the data collected by another sensor S2. In this case, S1 can be a substitution for S2 and vice versa. For example, the wind turbine axis torque could be approximately represented by the amount of vibration generated by generator and vice versa. Such a substitutional relationship can be obtained based on domain knowledge and/or data analysis (such as correlation analysis). Substitute sensors allow fault tolerance: when one sensor is not functional, the other sensor can be used as a substitute to build the solution.

When the supervised machine learning models are built to solve the business problems, the labels (or targets, dependent variables) associated with the features (or attributes, independent variables) are needed. Such labels are usually collected manually. The labels can also be generated through unsupervised model algorithms and get verified by the domain experts before using them for labels. Note the “Labels” component in the solution architecture diagram is needed only for supervised machine learning models, and is not needed for unsupervised machine learning model.

Model drift needs to be detected in time to avoid inaccurate model inference outcomes, which in turn impact the business. There are two types of model drifts: one is data drift and the other is concept drift. Example implementations described herein involve algorithms to detect both data drift and concept drift, respectively.

Data drift means that the distribution of input data (or features) shifts between the training environment and testing (or live) environment. The distribution here can involve a distribution for one variable (or feature, attribute) or multiple variables (or features, attributes). As a result, the machine learning model built based on the training data may not be suitable for the input data in the testing environment. Example implementations can involve two types of algorithms: one type of algorithm is to examine the data from a single sensor each time and try to determine if there is data drift, thus called uni-variate data drift detection; the other type of algorithms is to examine the data from two or more similar (i.e., highly correlated) sensors, thus call bi-variate data drift detection.

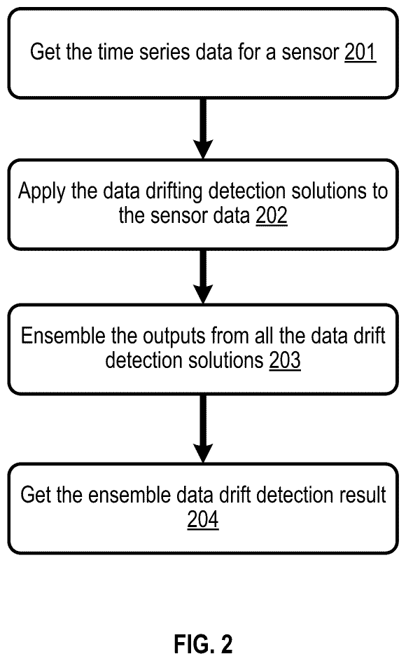

FIG. 2 illustrates the workflow of the uni-variate data drift detection, in accordance with an example implementation. Here is a description of the algorithm. At 201, the algorithm first obtains time series data for each sensor, and represents the values in time series as a vector. Sensors can be physical sensors and/or virtual sensors that are computed from physics-based models or digital twin models. At 202, the algorithm obtains the statistical significance test score for each value (or data point) in the time series data. To do so, the algorithm obtains the distribution of the time series data and for each data point, and calculates the statistical significance score (such as t-test score), which measures the location of the point in the distribution.

At 203, the algorithm takes both the time series data and the statistical significance test score, and applies clustering methods to automatically group the training data into multiple clusters. At 204, the algorithm assigns each data point in the testing data into the clusters that are derived at 203 and calculates the Population Stability Index (PSI). Population stability index (PSI) is a metric to measure how much a variable has shifted in distribution between two samples or over time. The PSI index can be calculated through the use of any open source package known in the art based on the desired implementation. Determine the PSI index value indicates a change in the distribution between training data and testing data:
PSI<0.1: no significant change
PSI<0.2: moderate change
PSI>=0.2: significant change

Some other algorithms can be applied to detect data drifts. Below are several possibilities in accordance with the desired implementation. The following algorithms will perform the same data collection described above.

Monotonic trend detection: if data has monotonic trend, then the distribution will change along the time and thus the statistics (such as the mean) about the distribution will change accordingly. First, the trend detection algorithm calculates the moving average of the time series data and significance scores. Second, the trend detection algorithm detects the trend in the moving average data. Statistical tests, like t-test, or Mann-Kendall test, can be used to detect the trend in the data. Third, if there is a trend, the mean value of testing data is compared with the mean value in the historical data. If the difference of the mean values are greater than a predefined threshold, then the data drift exists.

Statistical testing: Kolmogorov-Smirnov (K-S) test is a nonparametric test that compares the cumulative distributions of two data sets. In this case, the series of data is split into training data (historical) and testing data (latest real time data) first, then the K-S test is applied to determine if the distribution of testing data is different from the distribution of training data.

Population Stability Index: the series of data is split into training data and testing data, and the data values for both training data and testing data are split (e.g., manually) into a predefined number of buckets and use the PSI formula to calculate PSI index.

Ensemble Methods: each of the above methods can run independently and detect the data drift, if the data drift exists. The results from two or more of them can also be ensembled, and aggregate the results to get the final result. The aggregation can be done in two ways: if the data is a numerical value, then the average, minimum, or maximum values are calculated; if the data is a categorical value, then majority vote is used to get the most frequent result as the final result.

When sensors are installed on the industrial assets, a subset (two or more) of the sensors may capture similar data. One reason is due to the fault tolerance design. For example, some critical sensors may require redundant sensors to meet the system monitoring requirement. The other reason is that the sensors may have some internal physical property relationships and the data they captured have very high correlations among them. The similarity relationship among the sensors can be used to detect data drifts.

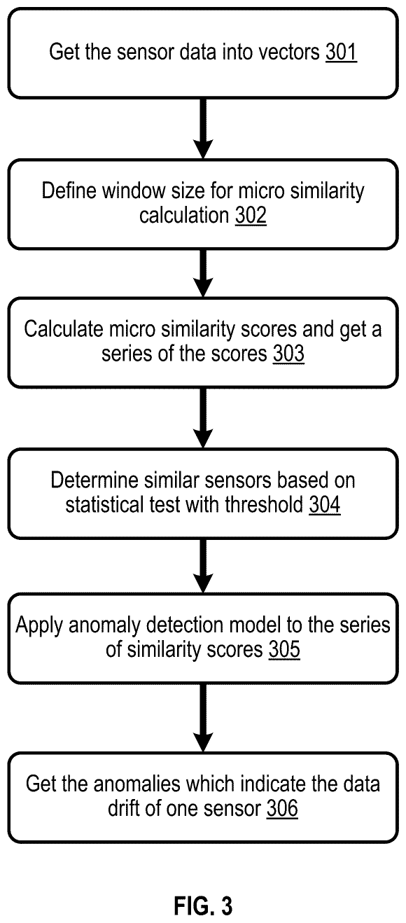

FIG. 3 illustrates the workflow for the bi-variate model drift detection algorithm, in accordance with an example implementation. Here is a description of the algorithm.

At first at 301, the algorithm obtains data for all the sensors, and take the values in time series for each sensor as a vector. Here, sensors can be physical sensors and/or virtual sensors from physics-based models or digital twin models depending on the desired implementation.

For each pair of sensors, the algorithm calculates window-based micro similarity scores, and gets a series of similarity scores. To calculate the window-based micro similarity scores, first, a window size is defined at 302 within which the data is used to calculate the similar score. For the data vectors of each pair of sensors, there will be many windows based on the predefined window size. The time windows can be rolling windows or adjacent windows. The time windows can also be event dependent (e.g., holiday season, business operation hours within a day, weekdays, weekends, and so on). Then, a series of similarity scores are calculated based on the data in time windows (or time segments). For each time window, the data vectors are obtained from a pair of sensors, and then the similarity score between the two vectors is calculated at 303. Here it is assumed that the length of the two vectors are the same, meaning that the sensor data are collected in the same time period and have the same data collection frequency. In case the data collection frequency for the two sensors are not the same, the data can be sampled to make the data frequency the same. To measure the similarity between two vectors, similarity metrics need to be chosen, which can include but are not limited to: correlation coefficient, cosine similarity, Hamming distance, Euclidean distance, Manhattan distance, and Minkowski Distance. Then, a distribution of the similarity scores can be obtained based on their values and frequencies. Micro similarity provides a fine-grained view of the similarity scores and thus is more informational and accurate to represent the similarity of two sensors.

At 304, to determine whether two sensors are similar, a statistical significance test is conducted to determine if a predefined similarity score threshold is significantly different from the distribution of similarity scores. For instance, a one-sample one-tail t-test can be used to determine if the similarity score threshold is significantly below the similarity scores. The flow first calculates a statistic based on the data for the similarity score threshold against the distribution of the similarity scores. Then, based on the significance level, the flow can determine whether the similarity score threshold is significantly below the similarity scores. In this case, the focus is on one-tail test (i.e., the left tail in the distribution of similarity scores).

At 305, if the two sensors under consideration are similar to each other, the anomaly detection method is applied to the series of similarity scores and to identify the anomalies. The similarity scores are calculated for both training data and testing data (either real time or in batch) and the anomaly detection model is applied to the series of the similarity scores for both training data and testing data. If the anomaly score is above a predefined threshold, it indicates one of the sensor data has drift at 306.

There can also be more than two similar sensors. Example implementations described herein can use one sensor as a target and the rest as features to build the ML model and then select important features which correspond to a set of sensors (i.e., cohort sensors) as similar sensors to the target sensor.

Further, the introduced algorithms to detect data drift for one single sensor can be applied to a series of similarity scores data to detect data drift in similar sensors: if there is data drift in the series of similarity score data, then there is a data drift in one of the sensor data. Such technique includes: clustering PSI, Monotonic trend detection, Kolmogorov-Smirnov (K-S) test, and Population Stability Index.

In addition, each of the above methods can run independently and detect the data drift, if the data drift exists. The results can also be ensembled across multiple results and aggregated to get the final result. The aggregation can be done in two ways: if the data is a numerical value, then the average, minimum, or maximum values can be used; if the data is a categorical value, then majority vote can be used to get the most frequent result as the final result.

In a micro similarity approach, if there are too many time windows, the calculation may take too much time and too many resources to run. Bootstrapping techniques can be used to solve such problems. Essentially, once the windowing strategy is applied and all the time windows are defined, bootstrapping techniques can be used to sample the time windows with replacement by a predefined sampling rate (e.g., 0.01). Then the micro similarity approach can be applied to calculate a series of similarity scores, the distribution of the similarity score and then compare the similarity score threshold with the distribution of similarity scores with statistical significance test. The result is then recorded for this run. Several runs of the bootstrapping sampling and application of micro similarity approach are continued to get the results for a predefined number of runs. The results from several runs can be aggregated to get a final result. Since the result from each run is a binary value to indicate whether the similarity score is significantly below the similarity scores, the “majority vote” technique can be used to see which value dominates the results and use that as the final result.

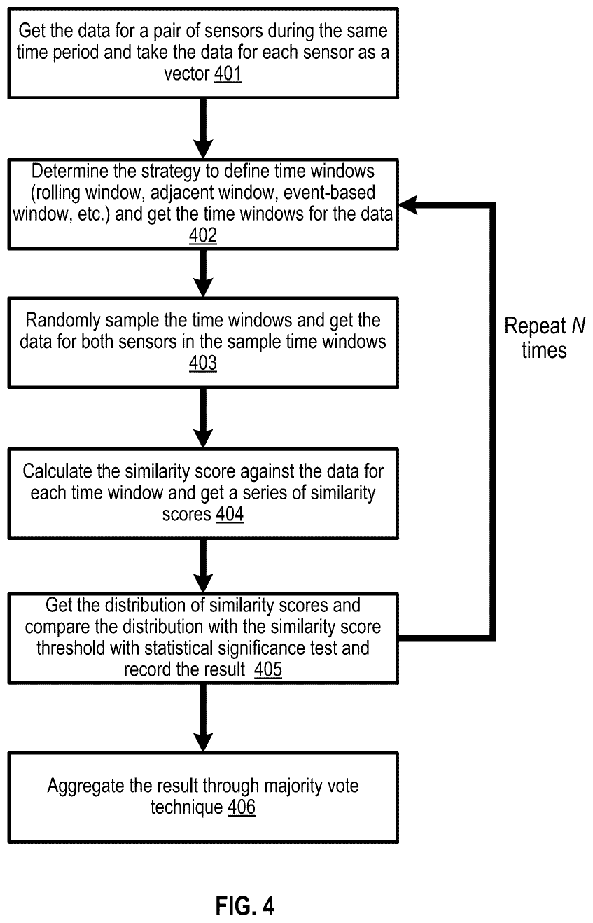

FIG. 4 illustrates the workflow of the Bootstrap Micro Similarity, in accordance with an example implementation. The workflow of the Bootstrap Micro Similarity is as follows. At 401, the flow obtains the data for a pair of sensors during the same time period and takes the data for each sensor as a vector.

At 402, the flow determines the strategy to define time windows (rolling window, adjacent window, event-based window, and so on) and get the time windows for the data. At 403, the flow randomly samples the time windows and obtains the data for both sensors in the sample time windows. At 404, the flow calculates the similarity score against the data for each time window and gets a series of similarity scores. At 405, the flow gets the distribution of similarity scores and compares the distribution with the similarity score threshold with statistical significance test and record the result. The flow from 402 to 405 can be repeated in accordance with the desired implementation until the sufficient results are obtained so as to aggregate the results through majority vote technique at 406.

The bootstrapping micro similarity transforms the original calculation against big vectors into multiple calculations on small vectors, which lower the hardware requirements. As a result, calculation on the edge devices can be enabled with these approaches.

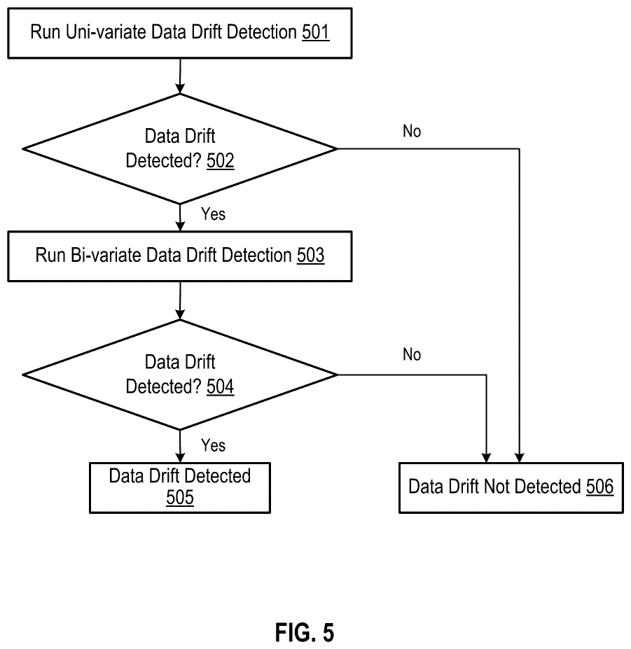

FIG. 5 describes a composite data drift detection approach, which introduces a logic to utilize both uni-variate and bi-variate data drift detection approaches, in accordance with an example implementation. For the sensor of the interest, when uni-variate data drift detection is used, the detected data drift may reflect the actual operational behaviors for the sensor of the interest. In order to exclude the abnormal operational behaviors from the detected data drifts, the bi-variate data drift detection algorithm can be utilized: if no data drift is detected from the bi-variate data drift detection algorithm, then that means both sensors change in the same way, and thus the change detected the in sensor of the interest is more likely to reflect the abnormal operational behaviors. Otherwise, it is more likely to be data drift for the sensor of the interest. The following is a description of the algorithm.

At 501, for the sensor of the interest, the flow runs univariate data drift detection model against the vector of the sensor data. At 502, if a data drift is not detected (no), then there is no data drift from the sensor and the flow proceeds to 506. If a data drift is detected (yes), then the flow proceeds to 503 to run bivariate data drift detection algorithm against the vectors of the sensor of the interest and the similar sensor. At 504, if a data drift is detected (yes), then the data drift is detected for the sensor of the interest at 505. Otherwise (no), the data drift is not detected for the sensor of the interest at 506.

Concept drift means the pattern or the relationship between the features input and target output changes. The first type of the concept drift is due to the change of the label/target (i.e., the dependent variables). Since label/target is a single variable, the same technique as used in the uni-variate data drift detection technique can be used to detect the drift in the label. First, obtain the target or label as a time-series data and represent it as a vector. The flow then applies the approach(es) in the Uni-variate Data Drift Detection to detect the drift in label (i.e., the concept drift).

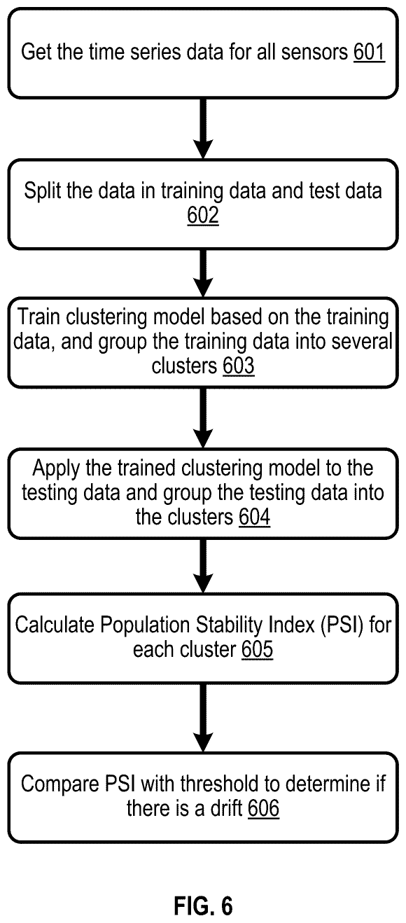

The second type of the concept drift is due to the change of the patterns in the features (i.e., the independent variables). FIG. 6 is an illustration of the Multi-variate Concept Drifting Detection, in accordance with an example implementation. Specifically, FIG. 6 describes an algorithm that is applied to all the features (similar to the clustering PSI algorithm as described herein), as follows. At first, the flow splits the data into training data and testing data, and gets the training data features and testing data features at 601 and 602.

At 603, the flow then trains a clustering algorithm with all the features in the training data. Note that there are multi-variate clustering algorithms, such as k-means, DB-Scan, and so on, that can be applied to multiple features concurrently. At 604, the flow applies the trained clustering model to the testing data, and assigns each data point in the testing data to a cluster derived from the trained clustering model. At 605, the PSI index is calculated and determines if the distribution of all the features between training data and testing data have changed at 606 to determine if there is a drift.

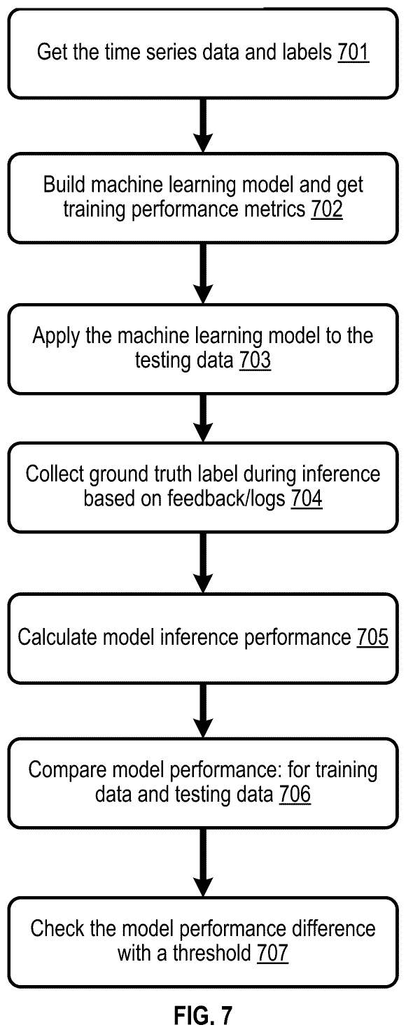

The third type of the concept drift is due to the relationships (or the mappings) between features and target undergoing changes. FIG. 7 illustrates an algorithm to detect the concept drift based on model performance during training phase and testing phase, in accordance with an example implementation. At first, the time series data and labels are obtained at 701. At 702, The machine learning model can be trained at 701 based on the training data, and get the training model performance.

At 703, the trained machine learning model is applied to the testing data, which could be the live stream data or batch data. The prediction results for the testing data are passed to the users. At 704, ground truth data is collected for the testing data, which can be used to calculate the model performance for the testing data at 705. Feedback can be collected at the alert/event level. The user may have three types of responses: acknowledgement, rejection or no response. The acknowledgement essentially translates to “true positive” cases, while “rejection”is translated to “false positive”cases.

Positive events in the logs, downtime logs and/or work order database can be collected. If the positive events (that are recorded in logs and/or databases) are captured by the machine learning models, that indicates “true positive” cases; otherwise, if the positive events are not captured by the machine learning models, that indicates “false negative” cases. Based on the “true positive” cases, “false positive” cases, and “false negative” cases, the model performance for the testing data can be calculated.

At 706, the flow compares the model performance metrics for training data and model performance metrics for testing data. At 707, if the model performance for testing data is worse than the model performance for training data by a predefined threshold, that means there is a concept drift.

The above approaches for concept drift can also be ensembled with majority vote. For example, if the results from more than two out of three approaches say there is a concept drift, then there is a concept drift; otherwise, there is not a concept drift.

Other approaches can also be used in conjunction with, or in replacement of the several data drifting detection and concept drifting detection algorithms described herein. Below are more example approaches.

First, the results from more than one approaches for data drift detection and concept drift detection can be ensembled. Second, with the data drifting algorithms, if the data drift is detected for the data, then all the machine learning models that use the data will get impacted. Third, with the concept drifting algorithms, if the concept drift is detected for the labels, then all of the machine learning models that use the labels will get impacted. If the concept drift is detected for all the features, then all the machine learning models that use the features will get impacted. If the concept drift is detected based on the model performance for a machine learning model of the interest, then all the machine learning models that use the features or labels for the machine learning model of the interest will get impacted.

With model detection techniques, the model drifts can be detected, including data drifts and concept drifts. With the detected drifts, it usually takes some time to replace the impacted machine learning model with a newer version of the model, which may leave the underlying system unmonitored due to the lack of the working machine learning model. It would be desirable to predict model drifts ahead of time, and remediate and avoid model drifts. Example implementations described herein involve a solution to predict the model drifts.

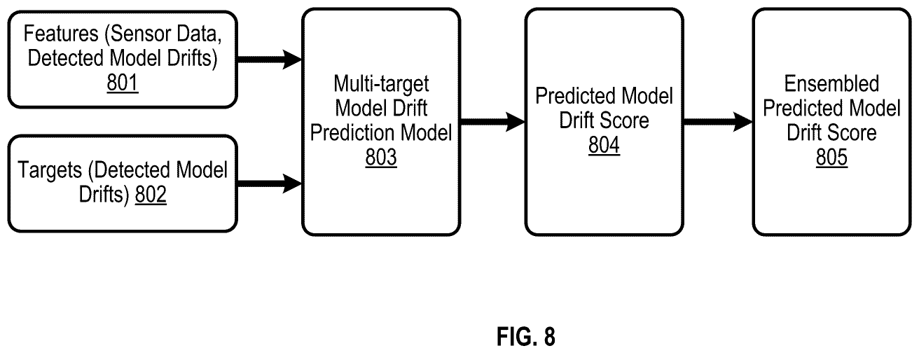

FIG. 8 illustrates a solution diagram for model drift prediction, in accordance with an example implementation. Here is a description of the model drift prediction solution.

Prepare features 801: for each sensor, the sensor data and the data from similar sensors (if available) are obtained. Both data drift detection algorithms and concept drift detection algorithms are applied to get multiple model drift scores, which are the output of multiple drift detection algorithms. Both the sensor data and drifting scores at the current time will be used as the features. Sometimes, we may look back a window to collect and concatenate the sensor data and the model drift scores within the look-back window as features.

Prepare multiple targets 802: the multiple model drift scores at a future time will be used as the target/label. The length of future time depends on the business needs, which usually comes from business requirements.

Build and execute a Machine Learning Model 803: Build one sequence prediction model for multiple targets. The deep learning Recurrent Neural Network (RNN) models can be used to predict multiple targets (i.e., multiple model drift scores) at the same time. The RNN model can be Long Short-Term Memory (LSTM), Gradient Recurrent Unit (GRU), and so on.

Ensemble of output from the model 804 and 805: multiple prediction scores are aggregated to obtain one single prediction model drift score. If the model drift scores are numerical values, some aggregation metrics, including but not limited to minimum, maximum, or average, can be used. If the model drift scores are categorical values, the results can be aggregated through majority vote approach, that is, the final result is the one that appears the most frequently.

After the model drifts are detected and predicted, some actions need to be taken to remediate or avoid the model drift. Several remediation strategies on model drifts are provided below.

For data drift, the drifted sensor should be calibrated or replaced.

For concept drift, the root cause analysis through Explainable AI (such as ELI5 and SHAP) is performed to identify the root cause of the concept drift. If it is related to a particular sensor, then the sensor needs to be calibrated or replaced. If it is related to a label, the model is retrained with the data that has the same or similar distribution as the testing data.

Further, a check can be done as to whether a drifted sensor has a similar sensor. If the answer is yes, use the similar sensor for the downstream tasks. At the same time, the drifted sensor can be calibrated or replaced. Otherwise, the drifted sensor needs to be calibrated or replaced immediately. Further, digital twin models can be built, and the output of the digital twin models (i.e., virtual sensors) can be used to complement and validate the physical sensors.

There are two special cases in the multi-sensor environment.

Geolocation-based data drift remediation: if the same type of sensors is installed sequentially in a pipeline, then upstream and downstream sensors can be used to impute the drifted sensor.

Time-based data drift remediation: when the sensor has some drift values (which may be due to the operation pause), the missing data can be interpolated based on the data that are collected before and after the time with missing data.

Described herein are several algorithms for model drift detection, prediction and remediation for an individual asset. However, in an industrial system, there are usually multiple assets and there are some relationships among them. The relationships among assets in an industrial system define the asset hierarchy, which can be compositional (or parent-child), sequential, or in general non-cyclic relationships among assets.

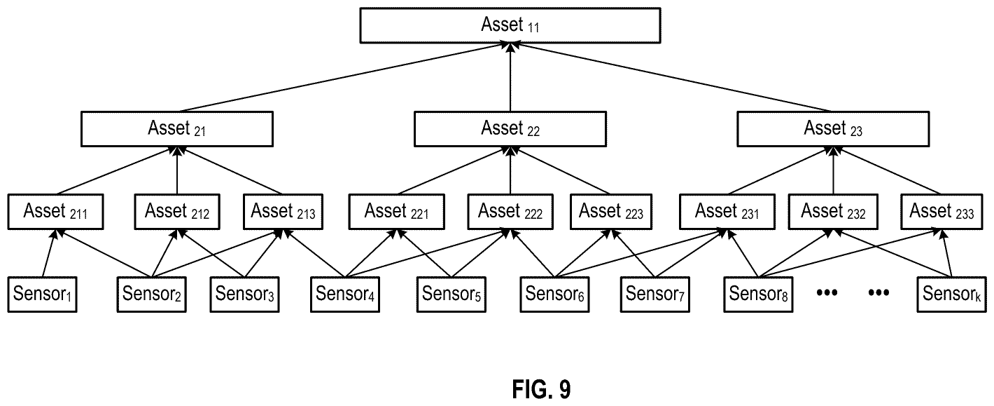

FIG. 9 illustrates an example of asset hierarchy in a compositional relationship among assets, in accordance with an example implementation. This asset hierarchy not only includes the assets in an industrial system, but also the sensors that are installed onto some assets. In this example, “Asset₁₁” is the asset at the highest level (i.e., root asset); “Asset₂₁”, “Asset₂₂” and “Asset₂₃” are assets at the next highest levels, and so on. The direct relationships among the assets are represented with the arrows. For example, “Asset₁₁” has a direct relationship with “Asset₂₁”, “Asset₂₂” and “Asset₂₃”. The relationship can be physical and/or logical. Besides, for the sensors, Sensor₁ is related to Asset₂₁₁, while Sensor₂ is related to Asset₂₁₁, Asset₂₁₂ and Asset₂₁₃.

Below is a description of the algorithm to detect, predict and remediate model drifts in an asset hierarchy. At first, the physical structure of the asset hierarchy is obtained. As described earlier, the relationships among assets can be compositional (parent-child), sequential, or in general non-cyclic. Next, the logical structure of the asset hierarchy is created. For example, if a solution only needs a subset of the assets and/or relationships, the logical structure can be defined as a subset of the physical asset hierarchy, in terms of both assets and relationships. Then sensors are identified that are applied to each leaf asset.

Given a business problem, machine learning models/solutions can be built for each asset in the asset hierarchy, as follows. At first, a model/solution for each leaf asset is built. Next, the output of each model at the lower level serves as input to the model at the next immediate higher level by following asset hierarchy. The model output from the lower level assets can be deemed as derived features to the model at the next immediate higher level by following asset hierarchy. Optionally, sensor data can be also input to each asset/node in the asset hierarchy.

Then, the model drift detection and prediction algorithms are applied to the asset from the lower level to the upper level. To do so, the algorithm detects or predicts data drifts at “sensor” level. The algorithm then detects concept drift at each “asset” level, from the lower level assets to the upper level assets. Any drift (including data drift and concept drift) detected/predicted at lower level will cause the drift at higher level. For assets with multiple machine learning solutions, the concept drift for one solution may cause concept drifts for other solutions.

Further, several variations to the algorithms described above can be used. Below are some examples.

Multi-tasking: multiple machine learning tasks can be done at the same time. Each asset can be associated with several machine learning models/solutions for different tasks: anomaly detection, clustering, failure detection, remaining useful life, failure prediction, etc.

Multi-versions: Each task can have several versions of the models based on model algorithms.

Semi-empirical: Machine learning models and/or physics-based models can be included. In such cases, physics-based model has the same output as the machine learning model(s).

Through the example implementations described herein, several advantages may be obtained. For example, the example implementations introduce automatic data-driven approaches to detect, predict and remediate model drifts in real time. Both data drifts and concepts drifts are covered in the model drifts. Several generic algorithms are introduced for data drift detection and concept drift detections. Model drifts can be predicted through multi-target sequence prediction model ahead of time, which allows some time for the remediation to minimize or avoid the adverse impact. Model drift detection, prediction and remediation are provided only as needed: right time for the right sensors and solutions. “Right time” avoids unnecessary inspection; and can be real time based. “Right sensors and solutions” only means that the model drifting detection, prediction and remediation is only applied to the sensors and the solutions of the interests. Both physical sensors and/or virtual sensors (from digital twin models) are incorporated into this solution framework.

Further, the example implementations introduce algorithms to detect and predict model drifts in asset hierarchy, which covers compositional (i.e., parent-child) relationship, sequential relationship, or in general the non-cyclic relationship among assets. In addition, the data drifts in sensors and system operational abnormal behaviors (or anomalies) are distinguished.

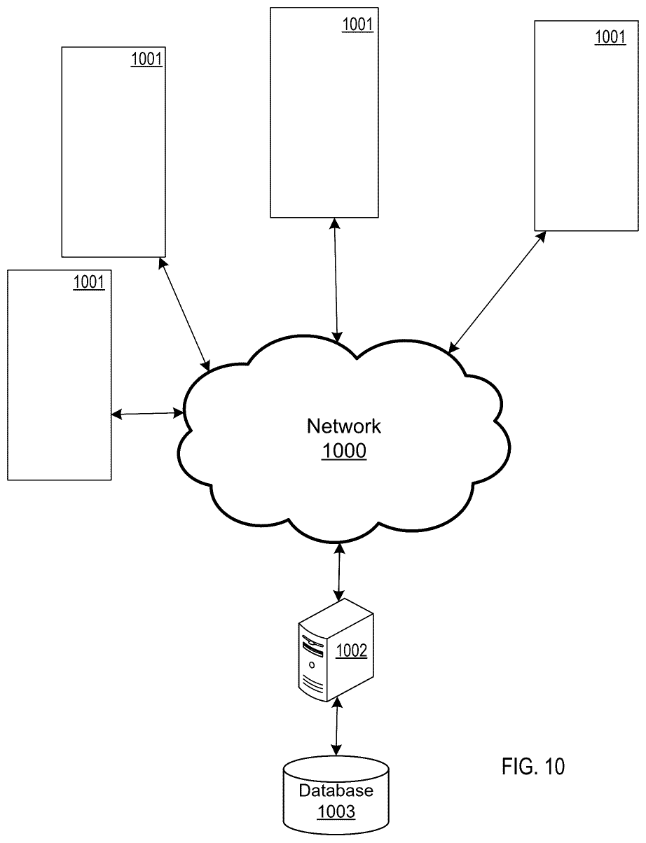

FIG. 10 illustrates a system involving a plurality of physical systems networked to a management apparatus, in accordance with an example implementation. One or more physical systems 1001 integrated with various sensors are communicatively coupled to a network 1000 (e.g., local area network (LAN), wide area network (WAN)) through the corresponding network interface of the sensor system installed in the physical systems 1001, which is connected to a management apparatus 1002. The management apparatus 1002 manages a database 1003, which contains historical data collected from the sensor systems from each of the physical systems 1001. In alternate example implementations, the data from the sensor systems of the physical systems 1001 can be stored to a central repository or central database such as proprietary databases that intake data from the physical systems 1001, or systems such as enterprise resource planning systems, and the management apparatus 1002 can access or retrieve the data from the central repository or central database. The sensor systems of the physical systems 1001 can include any type of sensors to facilitate the desired implementation, such as but not limited to gyroscopes, accelerometers, global positioning satellite (GPS), thermometers, humidity gauges, or any sensors that can measure one or more of temperature, humidity, gas levels (e.g., CO2 gas), and so on. Examples of physical systems can include, but are not limited to, shipping containers, lathes, air compressors, and so on. Further, the physical systems can also be represented as virtual systems, such as in the form of a digital twin.

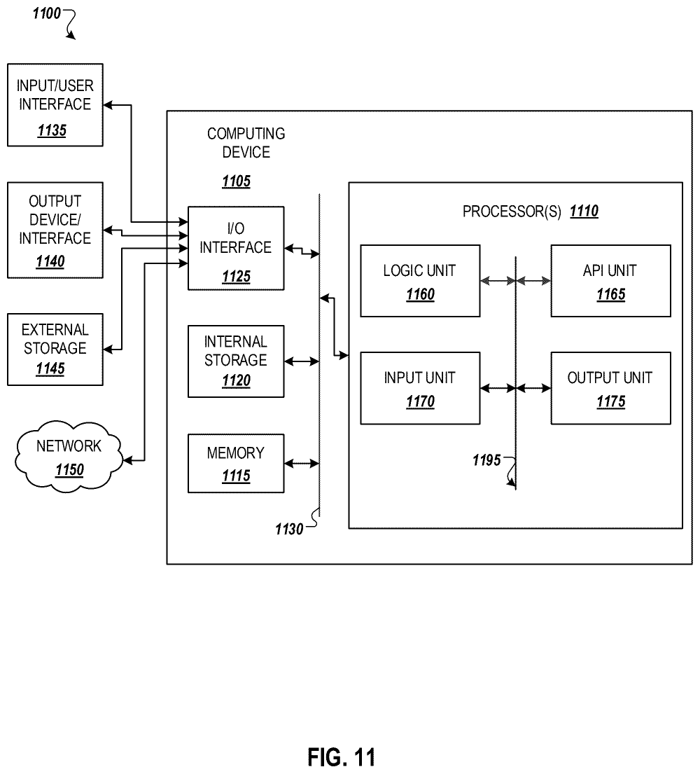

FIG. 11 illustrates an example computing environment with an example computer device suitable for use in some example implementations, such as a management apparatus 1002 as illustrated in FIG. 10. Computer device 1105 in computing environment 1100 can include one or more processing units, cores, or processors 1110, memory 1115 (e.g., RAM, ROM, and/or the like), internal storage 1120 (e.g., magnetic, optical, solid state storage, and/or organic), and/or I/O interface 1125, any of which can be coupled on a communication mechanism or bus 1130 for communicating information or embedded in the computer device 1105. I/O interface 1125 is also configured to receive images from cameras or provide images to projectors or displays, depending on the desired implementation.

Computer device 1105 can be communicatively coupled to input/user interface 1135 and output device/interface 1140. Either one or both of input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via I/O interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

I/O interface 1125 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, input unit 1170, output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide output based on the calculations described in example implementations.

Processor(s) 1110 can be configured to execute a method or computer instructions for model drift management of one or more machine learning models deployed across one or more physical systems, which can involve executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and executing a second process configured to predict model drift from the one or more deployed machine learning models, the second process configured to intake the output detected model drifts from the first process and the time series sensor data to output predicted model drift of the one or more deployed machine learning models as illustrated in FIG. 1.

Processor(s) 1110 can be configured to execute the method or computer instructions as described herein which can further include executing a remediation process 105 configured to correct model drift on the one or more deployed machine learning models based on the output detected model drift and the output predicted model drift.

Processor(s) 1110 can be configured to execute the method or computer instructions as described herein, wherein the first process can involve parsing the time series sensor data into training data and testing data; determining a statistical significance test score for each value in the training data; clustering the training data based on the statistical significance test score to generate a plurality of clusters; applying the plurality of clusters to the testing data; executing one or more of Population Stability Index (PSI) or statistical testing to determine distribution change over time based on the applying of the plurality of clusters to the testing data; and providing the output detected model drift based on the distribution change exceeding a threshold as illustrated in FIGS. 2 and 6.

Processor(s) 1110 can be configured to execute the method or computer instructions as described herein, which can further involve, for the first process providing the output detected model drift indicative of an occurrence of model drift, executing a third process to modify the output detected model drift involving calculating, from similar sensors associated with the time series sensor data, similarity scores across a plurality of windows; executing an anomaly detection process to the similarity scores to generate an anomaly score; and modifying the output detected model drift for the anomaly score not exceeding a threshold as illustrated in FIG. 5.

Processor(s) 1110 can be configured to execute the method or computer instructions as described herein, wherein the first process can involve calculating, from similar sensors associated with the time series sensor data, similarity scores across a plurality of windows; executing an anomaly detection process to the similarity scores to generate an anomaly score; and providing the output detected model drift based on the anomaly score exceeding a threshold as illustrated in FIGS. 3 and 4.

Processor(s) 1110 can be configured to execute the method or computer instructions as described herein, which can further involve comprising parsing the time series sensor data into training data and testing data; wherein the first process is another machine learning model trained against the training data and configured to input the time series sensor data and the labels to determine model performance of the one or more deployed machine learning models against a ground truth derived from the testing data; wherein for the first process determining that a first model performance of the one or more deployed machine learning models against the testing data is worse than a second model performance of the one or more deployed machine learning models against the training data, providing the output detected model drift as illustrated in FIG. 7.

Processor(s) 1110 can be configured to execute a method or computer instructions as described herein, wherein the second process is a recurrent neural network (RNN) model configured to intake the output detected model drift and a target future time and provide the output predicted model drift at the target future time as illustrated in FIG. 8.

Processor(s) 1110 can be configured to execute the method or instructions as described herein, wherein the physical systems are configured in an asset hierarchy, wherein the one or more deployed machine learning models are deployed for each one of the physical systems in the asset hierarchy, wherein the first process and the second process are executed from lower level to higher level across the asset hierarchy as illustrated in FIG. 9.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for model drift management of one or more machine learning models deployed across one or more physical systems, the method comprising:
executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and
executing a second process configured to predict model drift from the one or more deployed machine learning models, the second process configured to intake the output detected model drifts from the first process and the time series sensor data to output predicted model drift of the one or more deployed machine learning models.

2. The method of claim 1, further comprising executing a remediation process configured to correct model drift on the one or more deployed machine learning models based on the output detected model drift and the output predicted model drift.

3. The method of claim 1, wherein the first process comprises:
parsing the time series sensor data into training data and testing data;
determining a statistical significance test score for each value in the training data;
clustering the training data based on the statistical significance test score to generate a plurality of clusters;
applying the plurality of clusters to the testing data;
executing one or more of Population Stability Index (PSI) or statistical testing to determine distribution change over time based on the applying of the plurality of clusters to the testing data; and
providing the output detected model drift based on the distribution change exceeding a threshold.

4. The method of claim 1, wherein, for the first process providing the output detected model drift indicative of an occurrence of model drift, executing a third process to modify the output detected model drift comprising:
calculating, from similar sensors associated with the time series sensor data, similarity scores across a plurality of windows;
executing an anomaly detection process to the similarity scores to generate an anomaly score; and
modifying the output detected model drift for the anomaly score not exceeding a threshold.

5. The method of claim 1, wherein the first process comprises:
calculating, from similar sensors associated with the time series sensor data, similarity scores across a plurality of windows;
executing an anomaly detection process to the similarity scores to generate an anomaly score; and
providing the output detected model drift based on the anomaly score exceeding a threshold.

6. The method of claim 1, further comprising parsing the time series sensor data into training data and testing data;
wherein the first process is another machine learning model trained against the training data and configured to input the time series sensor data and the labels to determine model performance of the one or more deployed machine learning models against a ground truth derived from the testing data;
wherein for the first process determining that a first model performance of the one or more deployed machine learning models against the testing data is worse than a second model performance of the one or more deployed machine learning models against the training data, providing the output detected model drift.

7. The method of claim 1, wherein the second process is a recurrent neural network (RNN) model configured to intake the output detected model drift and a target future time and provide the output predicted model drift at the target future time.

8. The method of claim 1, wherein the physical systems are configured in an asset hierarchy, wherein the one or more deployed machine learning models are deployed for each one of the physical systems in the asset hierarchy, wherein the first process and the second process are executed from lower level to higher level across the asset hierarchy.

9. A non-transitory computer readable medium, storing instructions for model drift management of one or more machine learning models deployed across one or more physical systems, the instructions comprising:
executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and
executing a second process configured to predict model drift from the one or more deployed machine learning models, the second process configured to intake the output detected model drifts from the first process and the time series sensor data to output predicted model drift of the one or more deployed machine learning models.

10. The non-transitory computer readable medium of claim 9, the instructions further comprising executing a remediation process configured to correct model drift on the one or more deployed machine learning models based on the output detected model drift and the output predicted model drift.

11. The non-transitory computer readable medium of claim 9, wherein the first process comprises:
parsing the time series sensor data into training data and testing data;
determining a statistical significance test score for each value in the training data;
clustering the training data based on the statistical significance test score to generate a plurality of clusters;
applying the plurality of clusters to the testing data;
executing one or more of Population Stability Index (PSI) or statistical testing to determine distribution change over time based on the applying of the plurality of clusters to the testing data; and
providing the output detected model drift based on the distribution change exceeding a threshold.

12. The non-transitory computer readable medium of claim 9, the instructions, wherein, for the first process providing the output detected model drift indicative of an occurrence of model drift, executing a third process to modify the output detected model drift comprising:
calculating, from similar sensors associated with the time series sensor data, similarity scores across a plurality of windows;
executing an anomaly detection process to the similarity scores to generate an anomaly score; and
modifying the output detected model drift for the anomaly score not exceeding a threshold.

13. The non-transitory computer readable medium of claim 9, wherein the first process comprises:
calculating, from similar sensors associated with the time series sensor data, similarity scores across a plurality of windows;
executing an anomaly detection process to the similarity scores to generate an anomaly score; and
providing the output detected model drift based on the anomaly score exceeding a threshold.

14. The non-transitory computer readable medium of claim 9, the instructions further comprising parsing the time series sensor data into training data and testing data;
wherein the first process is another machine learning model trained against the training data and configured to input the time series sensor data and the labels to determine model performance of the one or more deployed machine learning models against a ground truth derived from the testing data;
wherein for the first process determining that a first model performance of the one or more deployed machine learning models against the testing data is worse than a second model performance of the one or more deployed machine learning models against the training data, providing the output detected model drift.

15. The non-transitory computer readable medium of claim 9, wherein the second process is a recurrent neural network (RNN) model configured to intake the output detected model drift and a target future time and provide the output predicted model drift at the target future time.

16. The non-transitory computer readable medium of claim 9, wherein the physical systems are configured in an asset hierarchy, wherein the one or more deployed machine learning models are deployed for each one of the physical systems in the asset hierarchy, wherein the first process and the second process are executed from lower level to higher level across the asset hierarchy.

17. An apparatus for model drift management of one or more machine learning models deployed across one or more physical systems, the apparatus comprising:
a processor, configured to execute instructions comprising:
executing a first process configured to detect model drift occurring on the one or more deployed machine learning models in real time, the first process configured to intake time series sensor data of one or more physical systems and one or more labels associated with the time series sensor data to output detected model drift detected from the one or more deployed machine learning models; and
executing a second process configured to predict model drift from the one or more deployed machine learning models, the second process configured to intake the output detected model drifts from the first process and the time series sensor data to output predicted model drift of the one or more deployed machine learning models.
